(19) United States
(12) Patent Application Publication
(10) Pub. No.: US 2014/0032972 A1
(43) Pub. Date: Jan. 30, 2014

(54) METHOD OF ENGINEERING AND DIAGNOSING A FIELD DEVICE AND A SYSTEM THEREOF

(71) Applicants: Ganapathi RAMACHANDRA, Bangalore (IN); Ashwin Ramesh HERUR, Hassan (IN)

(72) Inventors: Ganapathi RAMACHANDRA, Bangalore (IN); Ashwin Ramesh HERUR, Hassan (IN)

(73) Assignee: ABB TECHNOLOGY LTD., Zurich (CH)

(21) Appl. No.: 14/042,195

(22) Filed: Sep. 30, 2013

Related U.S. Application Data
(63) Continuation of application No. PCT/IB2011/003124, filed on Dec. 22, 2011.

(30) Foreign Application Priority Data
Mar. 31, 2011 (IN) 1048/CHE/2011

(51) Int. Cl. G06F 11/26

(52) U.S. Cl. CPC G06F 11/26
USPC 714/37

(57) ABSTRACT

A method is disclosed for engineering a field device by an engineering tool, which method can include identifying the field device, and configuring, parameterizing, diagnosing and commissioning the field device. Diagnosing the field device can include identifying one or more parameters that cause an error. Diagnosing the field device by an engineering tool can include identifying the parameter that causes an error through a device specific command.

### RELATED APPLICATIONS

This application claims priority as a continuation application under 35 U.S.C. §120 to PCT/IB2011/003124, which was filed as an International Application on Dec. 22, 2011 designating the U.S., and which claims priority to Indian Application 1048/CHE/2011 filed in India on Mar. 31, 2011. The entire contents of these applications are hereby incorporated by reference in their entireties.

### FIELD

The present disclosure relates to a method of engineering a field device in a process industry to, for example, identify a conflicting parameter that causes an error, and also relates to a system thereof.

### BACKGROUND INFORMATION

Generally, the process control industry has field devices such as sensors, actuators, valve positioners and so forth which are used to monitor and/or control the process in a process industry. Each of these field devices can be engineered using a suitable engineering tool, so as to perform its function in the process industry in a desired manner.

Essentially, the process of engineering a field device by an engineering tool involves identifying the field device that is to be engineered, configuring the identified field device, parameterizing the field device, and diagnosing and commissioning the field device in the process industry.

Different engineering tools such as Device Type Manager (DTM), Device Description (DD) based Hand Held Terminal/device, Field Device Tool (FDT), Electronic Device Description Tool (EDDL) and so forth, are used in engineering the field devices using a suitable communications protocol like Highway Addressable Remote Transducer (HART) protocol and so forth.

During the engineering of the field device, the engineering tool parameterizes the field device for its corresponding parameters and values thereof. For example, parameters like 0% and 100% position adjustment are parameterized for an actuator. Similarly, upper and lower range values of static pressure and differential pressure are parameterized for a pressure transmitter.

The engineering tool runs a test routine to check the values of the parameters and its associated data field or command and of the validity of the parameters thereof, before the command containing these parameter values in its respective data field is downloaded into the field device. Upon successful check on the parameter values, the parameters are downloaded into the field device by the engineering tool. Following this, the engineering tool performs diagnosis for any errors in communication, the field device, commands and parameters and so forth.

The diagnosis of errors in parameter values can be important for proper functioning of the field device and the process industry thereof. Accordingly, the field device also can run an internal test routine within itself to check the validity of the parameters and its corresponding values that have been downloaded into the field device by the engineering tool. In the event that there are no errors or conflicts in the parameter values, and of the communication and the field device and so forth, the engineering tool performs commissioning of the field device.

Practically, there may be errors in the parameter values corresponding to a field device, even after those parameters have successfully passed the test routine run by the engineering tool before downloading them into the field device. In these circumstances, the field device sends an error response code to the engineering tool indicative of the error in the command. Based on the error code, it may be possible to relate the occurrence of the error to the parameter. However, this does not identify which parameter has caused the error.

Currently, each of the parameters in the command is checked for its validity which includes correctness of its value. This can become cumbersome when there are interdependent parameters corresponding to a field device. Also, this can be time consuming, and uncertainty can prevail until the parameter causing an error is identified.

Hence, it would be desirable for a method and a system to identify a parameter that causes an error, and the present disclosure provides solutions which can address these issues.

### SUMMARY

A method is disclosed of engineering a field device of a process control industry, by an engineering tool, the method comprising: identifying a field device to be engineered; configuring the field device with data in an instance data record; parameterizing the field device for its corresponding parameters and values thereof; diagnosing the field device for errors in communication, the field device, commands and parameters; and commissioning the field device, wherein diagnosing the field device includes identifying one or more conflicting parameters that will cause an error.

A method is disclosed of diagnosing a field device for an error in a parameter, by an engineering tool, the method comprising: testing the field device by running an internal test routine in the test field device; generating an error response code pertaining to one or more conflicting parameters that will cause an error, by the field device; sending the error response code to the engineering tool by the field device; and identifying one or more conflicting parameters that will cause an error, wherein identifying one or more conflicting parameters includes providing a device specific command to the field device by the engineering tool; checking one or more parameters in the command; identifying one or more conflicting parameters in the command that will cause an error; and responding to the device specific command by the field device to the engineering tool.

A system is disclosed for engineering a field device in a process industry, the system comprising: a system manager component; a network manager component; one or more gateways; one or more field devices; and an engineering tool, wherein the engineering tool is configured for identifying one or more conflicting parameters in a command, that will cause an error, the engineering tool being configured for: configuring a selected field device with data in an instance data record; parameterizing the selected field device for its corresponding parameters and values thereof; and diagnosing the selected field device for errors in communication, the field device, commands and parameters.

### BRIEF DESCRIPTION OF THE DRAWINGS

Features of the present disclosure will become more apparent from the following description of exemplary preferred embodiments when read with reference to the accompanying drawings in which:

FIG. 1. illustrates an exemplary method of engineering a field device in accordance with the present disclosure; and

FIG. 2. shows an exemplary sequence diagram depicting identifying a parameter that causes an error, in accordance with the present disclosure.

### DETAILED DESCRIPTION

Methods of engineering a field device and of diagnosing the field device for an error in the parameter are disclosed herein.

Methods of diagnosing a field device and of identifying a parameter causing an error are also disclosed.

Further, a system is disclosed to identify a parameter that causes an error, in accordance with the disclosed methods.

An exemplary method of engineering a field device in a process control industry is disclosed. Engineering of the field device by a suitable engineering tool can essentially comprise identifying the field device that is to be engineered, followed by configuring the field device. The data for configuring the field device can be taken from the instance data record. Parameterizing the field device for its corresponding parameters and values thereof is performed thereafter.

Following this, the engineering tool diagnoses the field device for any errors in communication or in the field device itself or in commands or parameters or any combination thereof. In the event of an error in a parameter, the engineering tool identifies the parameter that causes the error and rectification is done accordingly. Upon successful diagnosis, the field device is commissioned.

To this end, the present disclosure provides a method of diagnosing a field device for an error in a parameter, by an engineering tool. Diagnosing the field device for an error in parameter comprises, for example, testing the field device by running an internal test routine in the field device and thereupon generating an error response code pertaining to one or more conflicting parameters that causes the error or to that of the command containing such conflicting parameters, by the field device, in the event of occurrence of an error in the parameter. This can be followed by sending the error response code to the engineering tool by the field device; and identifying one or more conflicting parameters that causes the error by providing a device specific command to the field device by the engineering tool. Thereafter, one or more parameters in the command are checked and one or more conflicting parameters in the command that causes the error are identified. A response to the device specific command indicative of the conflicting parameter that causes the error, can be sent to the engineering tool by the field device.

The present disclosure also provides a system for engineering a field device in a process industry in accordance with the disclosed method. The system can comprise a system manager component, a network manager component, one or more gateways, one or more field devices and an engineering tool. The engineering tool can be capable of identifying one or more conflicting parameters in a command, which causes an error.

A system for engineering a field device in a process control industry can thus comprise a system manager component that manages the system, and a network manager component that manages the network in and of the system. One or more gateways are provided for having one or more field devices connected to the network and of the system thereof. An engineering tool is also provided, essentially for engineering the field device. The engineering tool disclosed herein can be capable of identifying one or more conflicting parameters in a command that causes an error.

An exemplary field device disclosed herein can be a sensor or actuator or valve positioner or the like and may be wired or wireless. With relevance to the present disclosure, the engineering tool can be one or more of a Device Type Manager, Device Description based Hand Held Terminal/device, Field Device Tool, Electronic Device Description Tool or the like. The engineering tool can utilize a communication protocol such as HART or the like.

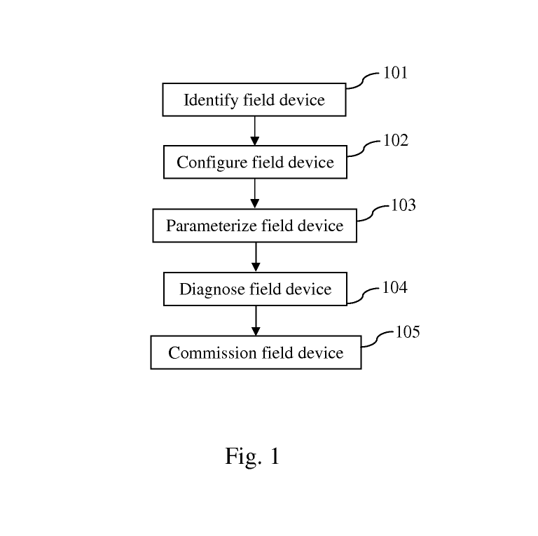

An exemplary method of engineering a field device in a process control industry, by an engineering tool, is shown in FIG. 1. The exemplary method of engineering the field device involves the steps of identifying the field device that is to be engineered (101). This is followed by configuring the field device with the data in an instance data record (102). The instance data record has information relating to engineering the field devices, including the information purporting to the network and parameters. Parameterizing the field devices by the engineering tool for its corresponding parameters and values thereof (103) is performed thereafter.

Where desired, diagnosis of the field devices can be performed for any errors in communication or of the field device itself or of commands or parameters or any combination of them (104). The diagnosis of parameters can involve identifying one or more conflicting parameters that has an error and eventually causes an error in engineering the field device. Upon diagnosing the field device for related errors, the field device is commissioned (105).

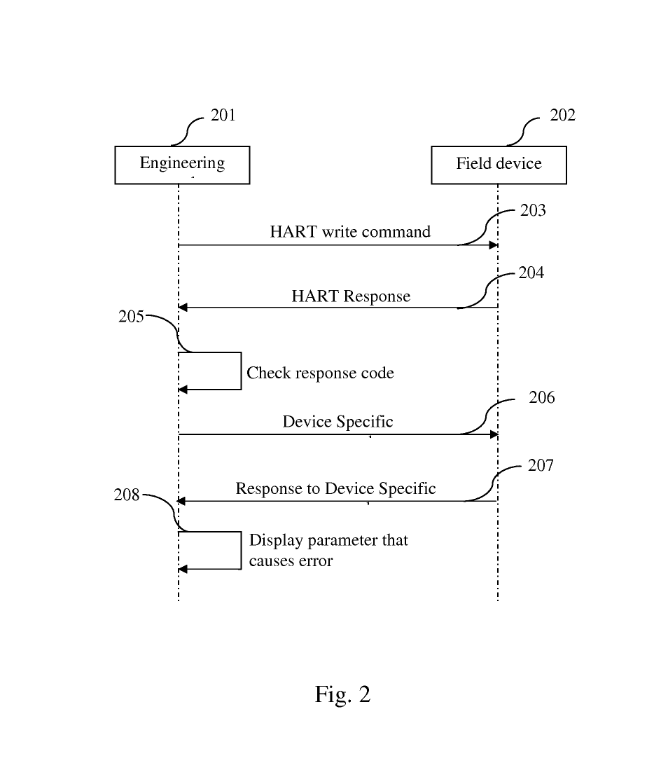

Referring to FIG. 2., an exemplary method of diagnosing a field device for an error in a parameter, by an engineering tool in accordance with the present disclosure is illustrated, with reference to a non-exhaustive exemplary embodiment of using a HART protocol as explained herein.

The engineering tool (201) writes a HART write command having the parameters pertaining to the field device in its data field (203), into the field device (202). The method of diagnosing the field device for an error in a parameter by an engineering tool involves testing the field device. The testing of the field device includes running an internal test routine with the field device for checking the validity of the parameters corresponding to the field device.

A response to the HART write command (204) (i.e., the HART response) is sent by the field device to the engineering tool. If there are no errors, the engineering tool proceeds to commission the field device. However, in the event of an error in one or more parameters, an error response code purporting to the HART response is sent by the field device to the engineering tool. It is to be noted that an error response code is generated by the field device and sent to the engineering tool for errors other than in a parameter also, for instance, an error in communication, field device, and so forth. The error response code is indicative of the occurrence of an error, in a parameter or a communication or a field device. The engineering tool checks the response code (205) to identify the cause for the error response code (i.e., to identify whether the error has been caused by the parameter or communication or the said field device itself based on the code in the HART response).

After the step 205 the engineering tool (201) sends a device specific command (206) to the field device (202). The device specific command field device is meant to identify one or more parameters that will cause, or cause an error. After receiving the device specific command, the field device checks the parameters for its validity and identifies the parameter that failed the previously run test routine inside the field device. The field device (202) sends a device specific command response (207) to the engineering tool (201), which purports to respond to the device specific command. The device specific command response is indicative of one or more parameters that causes an error. Thereafter, the parameter that caused an error and its associated error response code and of the command thereof are displayed (208) for taking further action in correcting them.

This way, it becomes more simplified to identify which parameter has caused an error and to provide for a correction.

It is to be noted that the present invention is explained by way of exemplary embodiments which are neither exhaustive nor limiting. Certain aspects of the invention that have not been elaborated will be understood by those skilled in the art. Also, the terms relating to singular form used herein in the description also include their plurality and vice versa, wherever applicable. Any relevant modification or variation, which is not described specifically in the specification should be construed to be well within the scope of the invention.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

We claim:

1. A method of engineering a field device of a process control industry, by an engineering tool, the method comprising:
identifying a field device to be engineered;
configuring the field device with data in an instance data record;
parameterizing the field device for its corresponding parameters and values thereof;
diagnosing the field device for errors in communication, the field device, commands and parameters; and
commissioning the field device, wherein diagnosing the field device includes identifying one or more conflicting parameters that will cause an error.

2. A method of diagnosing a field device for an error in a parameter, by an engineering tool, the method comprising:
testing the field device by running an internal test routine in the test field device;
generating an error response code pertaining to one or more conflicting parameters that will cause an error, by the field device;
sending the error response code to the engineering tool by the field device; and
identifying one or more conflicting parameters that will cause an error, wherein identifying one or more conflicting parameters includes providing a device specific command to the field device by the engineering tool;
checking one or more parameters in the command;
identifying one or more conflicting parameters in the command that will cause an error; and
responding to the device specific command by the field device to the engineering tool.

3. The method as claimed in claim 1, wherein the field device is a sensor or actuator or valve positioner.

4. The method as claimed in claim 1, wherein the field device is a wireless field device.

5. The method as claimed in claim 1, wherein the engineering tool is one or more of a Device Type Manager, a Device Description based Hand Held Terminal/device, a Field Device Tool, or an Electronic Device Description Tool.

6. The method as claimed in claim 1, wherein the engineering tool is configured for a Highway Addressable Remote Transducer communication protocol.

7. A system for engineering a field device in a process industry, the system comprising:
a system manager component;
a network manager component;
one or more gateways;
one or more field devices; and
an engineering tool, wherein the engineering tool is configured for identifying one or more conflicting parameters in a command, that will cause an error, the engineering tool being configured for:
configuring a selected field device with data in an instance data record;
parameterizing the selected field device for its corresponding parameters and values thereof; and
diagnosing the selected field device for errors in communication, the field device, commands and parameters.

8. The method as claimed in claim 2, wherein the field device is a sensor or actuator or valve positioner.

9. The method as claimed in claim 2, wherein the field device is a wireless field device.

10. The method as claimed in claim 2, wherein the engineering tool is one or more of a Device Type Manager, a Device Description based Hand Held Terminal/device, a Field Device Tool, or an Electronic Device Description Tool.

11. The method as claimed in claim 2, wherein the engineering tool is configured for a Highway Addressable Remote Transducer communication protocol.
